(19) United States
(12) Patent Application Publication
(10) Pub. No.: US 2018/0157646 A1
(43) Pub. Date: Jun. 7, 2018

(54) COMMAND TRANSFORMATION METHOD AND SYSTEM

(71) Applicant: INSTITUTE FOR INFORMATION INDUSTRY, TAIPEI (TW)

(72) Inventors: Ping-Che YANG, Taipei City (TW); Hsiang-Lun LIN, Taipei City (TW); Tsun KU, Taipei City (TW)

(21) Appl. No.: 15/368,695

(22) Filed: Dec. 5, 2016

(30) Foreign Application Priority Data
Dec. 1, 2016 (TW) 105139738

(51) Int. Cl. G06F 17/28; G06F 17/24

(52) U.S. Cl. CPC G06F 17/289; G06F 17/2795; G06F 17/24

(57) ABSTRACT

A command transformation method includes: receiving a natural language sentence associated with a first language; transforming the natural language sentence into an original text command; determining whether the original text command comprises an unknown word or not; transforming the unknown word into International Phonetic Alphabet (IPA) when the original text command comprises the unknown word, to generate at least one candidate word; searching a database according to the candidate word, to search out a first word corresponding to the unknown word and associated with the first language; replacing the unknown word with the first word, to generate a first machine readable command. The first machine readable command is configured to be executed by an electronic device to implement a corresponding operation.

### RELATED APPLICATIONS

This application claims priority to Taiwanese Application Serial Number 105139738, filed Dec. 1, 2016, which is herein incorporated by reference.

### BACKGROUND

### Technical Field

The present disclosure relates to a command transformation technology. More particularly, the present disclosure relates to a command transformation method, a command transformation system; and a non-transitory computer readable storage medium, which are able to be implemented in smart appliances.

### Description of Related Art

With the development of technology, various smart appliances are more popular. These smart appliances are able to perform corresponding operations according to voice inputs from users. However, under many conditions, the smart appliances are unable to correctly identify the voice inputs of the users. Especially, the smart appliances are unable to correctly identify a voice input when the voice input of a user is a natural language sentence, or when the voice input includes two languages, or when the voice input includes an unknown word which is not able to be identified. As a result, the smart appliances are unable to execute corresponding operations successfully.

### SUMMARY

One embodiment of the present disclosure is related to a command transformation method. The command transformation method is configured to transform a natural language sentence into a machine readable command. The command transformation method includes the steps: receiving the natural language sentence associated with a first language by a processor; transforming the natural language sentence into an original text command by the processor; determining whether the original text command comprises an unknown word or not by the processor; transforming the unknown word into International Phonetic Alphabet (IPA) by the processor when the original text command comprises the unknown word, to generate at least one candidate word; searching a database according to the candidate word by the processor, to search out a first word corresponding to the unknown word and associated with the first language; and replacing the unknown word with the first word by the processor, to generate a first machine readable command. The first machine readable command is configured to be executed by an electronic device to implement a corresponding operation.

Another embodiment of the present disclosure is related to a command transformation system. The command transformation system is configured to transform a natural language sentence into a machine readable command. The command transformation system includes a database and a processor. The processor is coupled to the database. The processor is configured to receive the natural language sentence associated with a first language and to transform the natural language sentence into an original text command. The processor is further configured to determine whether the original text command comprises an unknown word or not, the processor is further configured to transform the unknown word into International Phonetic Alphabet (IPA) when the original text command comprises the unknown word to generate at least one candidate word. The processor is further configured to search a database according to the candidate word to search out a first word corresponding to the unknown word and associated with the first language. The processor is further configured to replace the unknown word with the first word to generate a first machine readable command. The first machine readable command is configured to be executed by an electronic device to implement a corresponding operation.

Yet another embodiment of the present disclosure is related to a non-transitory computer readable storage medium storing a computer program. The computer program is configured to execute a command transformation method. The command transformation method is configured to transform a natural language sentence into a machine readable command. The command transformation method includes: receiving the natural language sentence associated with a first language; transforming the natural language sentence into an original text command; determining whether the original text command comprises an unknown word or not; transforming the unknown word into International Phonetic Alphabet (IPA) when the original text command comprises the unknown word, to generate at least one candidate word; searching a database according to the candidate word, to search out a first word corresponding to the unknown word and associated with the first language; and replacing the unknown word with the first word, to generate a first machine readable command. The first machine readable command is configured to be executed by an electronic device to implement a corresponding operation.

As the above embodiments, in the command transformation method and the command transformation system of this disclosure, the original text command including the unknown word is able to be transformed into the machine readable command. Thus, the electronic device is able to read the machine readable command to implement corresponding operations.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1A is a schematic diagram illustrating a command transformation system according to some embodiments of the present disclosure;

FIG. 1B is a function block diagram illustrating the command transformation system in FIG. 1A according to some embodiments of this disclosure;

FIG. 2 is a flow diagram illustrating a command transformation method according to some embodiments of this disclosure;

FIG. 3 is a flow diagram illustrating a command transformation method according to some embodiments of this disclosure; and

FIG. 4 is a flow diagram illustrating a command transformation method according to some embodiments of this disclosure.

### DETAILED DESCRIPTION

Reference will now be made in detail to the present embodiments of the disclosure, examples of which are illustrated in the accompanying, drawings. Wherever possible, the same reference numbers are used in the drawings and the description to refer to the same or like parts. The embodiments below are described in detail with the accompanying drawings, but the examples provided are not intended to limit the scope of the disclosure covered by the description. The structure and operation are not intended to limit the execution order. Any structure regrouped by elements, which has an equal effect, is covered by the scope of the present disclosure.

Moreover, the drawings are for the purpose of illustration only, and are not in accordance with the size of the original drawing. The components in description are described with the same number to understand.

As used herein, “coupled” may refer to two or more elements are in “direct” physical or electrical contact made, or “indirectly”, as a mutual entity or electrical contact, and may also refer to two or more elements are operating or action.

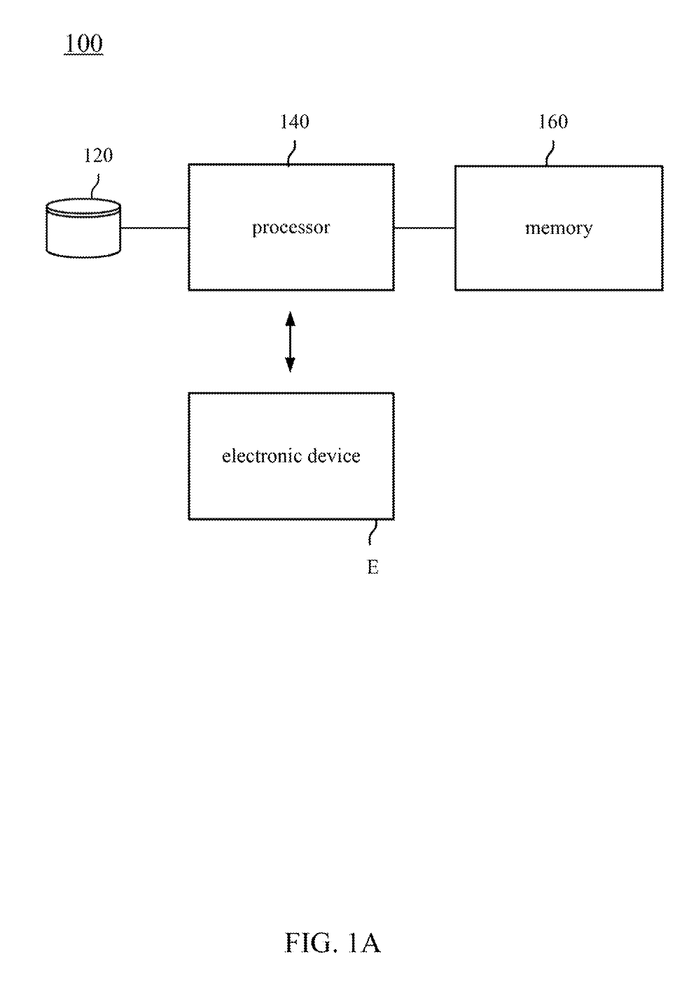

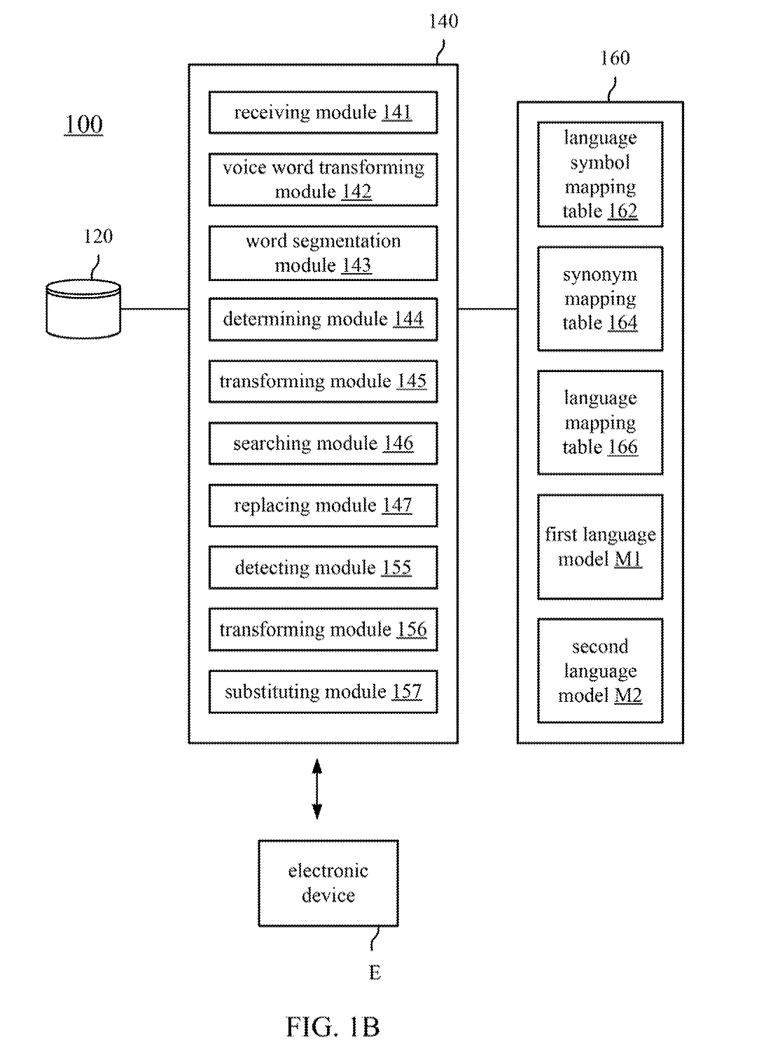

Reference is made to FIG. 1A. FIG. 1A is a schematic diagram illustrating a command transformation system 100 according to some embodiments of the present disclosure. As illustratively shown in FIG. 1A, the command transformation system 100 includes a database 120 and a processor 140. The processor 140 is coupled to the database 120.

In some embodiments, the database 120 a server or various databases. The database 120 may be composed of one or more databases. In some embodiments, the processor 140 is a CPU, a micro-processor, a processing circuit, or other hardware elements which are able to execute instructions, but is not limited thereto.

The processor 140 is configured to transform a sentence received into a machine readable command. As illustratively shown in FIG. 1A, the processor 140 transmits the machine readable command to an electronic device E through wireless communication. The electronic device E reads and executes the machine readable command, to implement correspond operations. In some embodiments, the electronic device E is a household electronic appliance. In some other embodiments, the processor 140 is disposed in the electronic device E.

In some embodiments, the command transformation system 100 further includes a memory 160. The memory 160 is coupled to the processor 140. In some embodiments, the processor 140 and the memory 160 are disposed in the electronic device E. In some other embodiments, the processor 140 and the memory 160 are disposed n another electronic device which communicates to the electronic device E through wireless communication.

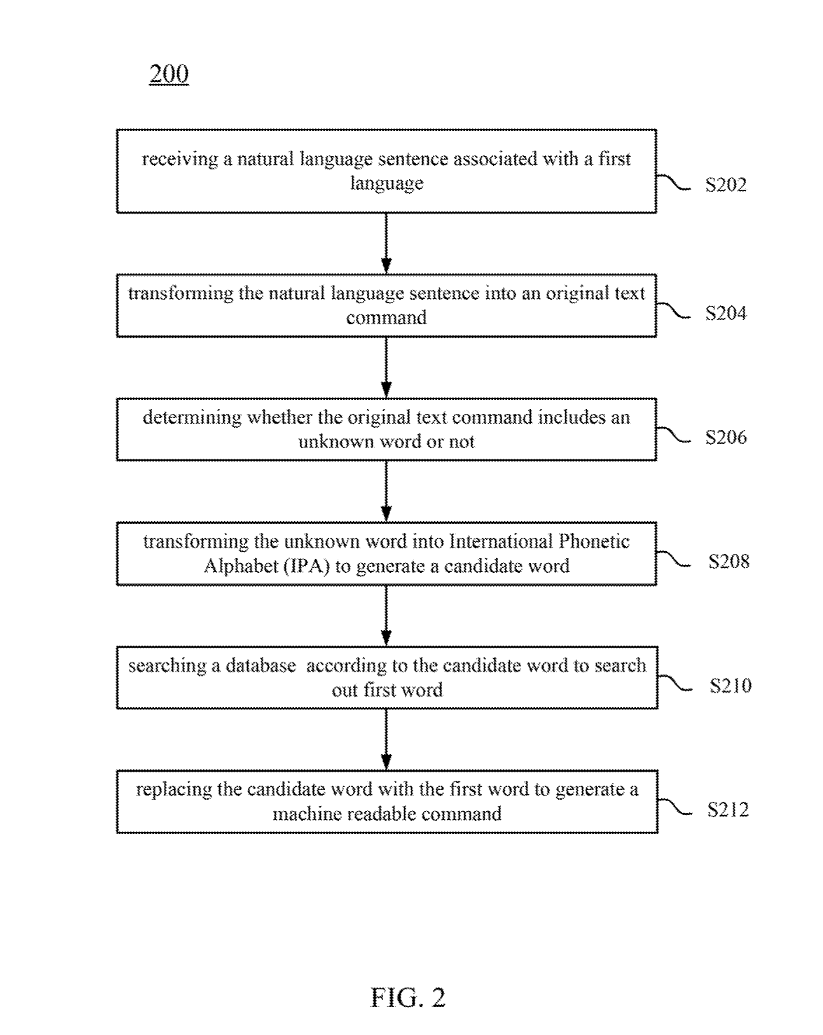

Reference is made to FIG. 1B. FIG. 1B is a function block diagram illustrating the command transformation system 100 in FIG. 1A according to some embodiments of this disclosure. Reference is made to FIG. 2. FIG. 2 is a flow diagram illustrating a command transformation method 200 according to some embodiments of this disclosure. For better understanding of the present disclosure, the command transformation method 200 is discussed in relation to the command transformation system 100 shown in FIG. 1B, but is not limited thereto.

In step S202, the processor 140 receives the natural language sentence associated with a first language. When a user wants to command the electronic device E to perform a specific operation, the user speaks one or more sentences. The one or more sentences are the natural language sentences. In some embodiments, the processor 140 includes a receiving module 141. The receiving module 141 is configured to receive the natural language sentence. The receiving module 141 is, for example, a microphone. The first language is, for example, English, Chinese, or other languages.

In step S204, the processor 140 transforms the natural language sentence into an original text command. In some embodiments, the processor 140 includes a voice word transforming module 142. The voice word transforming module 142 is configured to transform a voice input into corresponding words.

In step S206, the processor 140 determines whether the original text command includes an unknown word or not. In some embodiments, the processor 140 further includes a word segmentation module 143 and a determining module 144. The word segmentation module 143 performs a word segmentation to the original text command, to generate a plurality of words. Then, the determining module 144 determines whether the words includes the unknown word or not according to properties of the words and positions of the words in the sentences.

In step S208, when the original text command includes the unknown word, the processor 140 transforms the unknown word into International Phonetic Alphabet (IPA); to generate at least one candidate word′. In some embodiments, the processor 140 further includes a transforming module 145. When the determining module 144 determines that the aforementioned words include the unknown word, the transforming module 145 transforms the unknown word into International Phonetic Alphabet. The transformed International Phonetic Alphabet is the candidate word. Various transforming approaches are within the scope of the present disclosure.

In step S210, the processor 140 searches the database 120 according to the candidate word. In some embodiments, the processor 140 further includes a searching module 146. The searching module 146 searches the database 120 according to the candidate word, to search out a first word. The first word is corresponding to the unknown word and associated with the first language.

In step S212, the processor 140 replaces the candidate word with the first word. In some embodiments, the processor 140 further includes a replacing module 147. The replacing module 147 replaces the candidate word with the first word which is searched out, to generate a first machine readable command. The electronic device E reads and executes the first machine readable command, to implement corresponding operations.

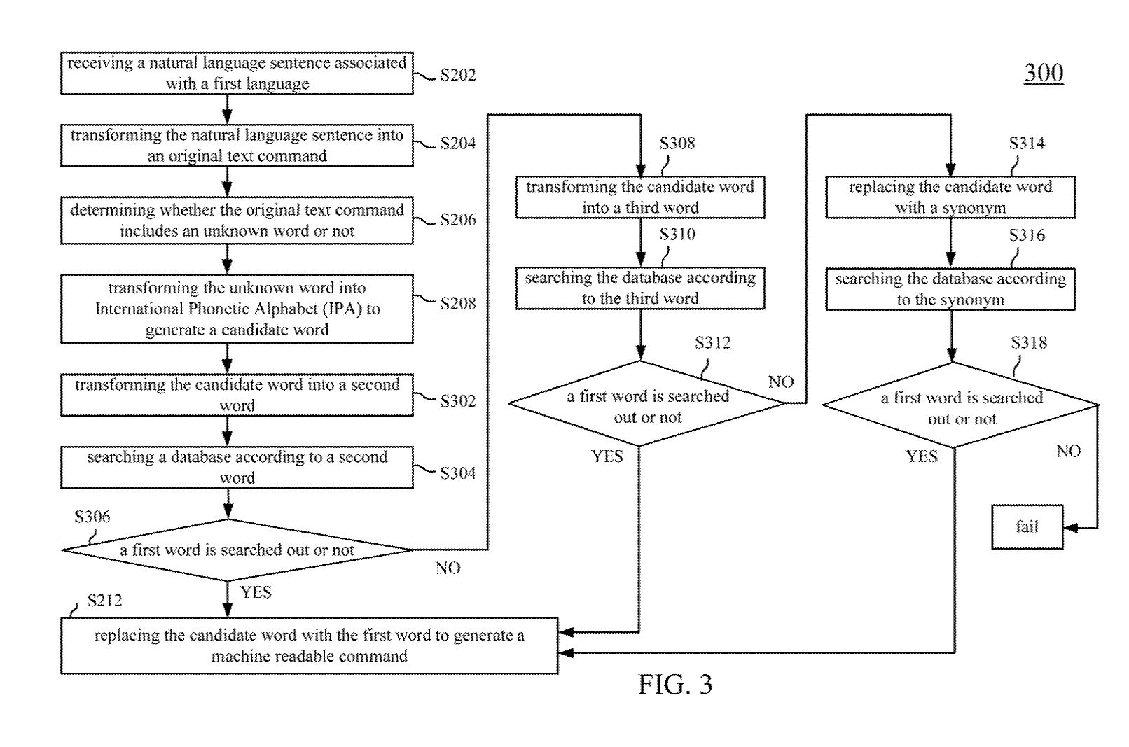

Reference is made to FIG. 3. FIG. 3 is a flow diagram illustrating a command transformation method 300 according to some embodiments of this disclosure. For ease of understanding, with respect to the embodiments of FIG. 2, like steps in FIG. 3 are designated with the same reference numbers. Only the steps in FIG. 3 which are different from the command transformation method 200 are described in following description.

In step S302, the processor 140 transforms the candidate word into a second word. As least some phonetic symbols of the second word is the same as at least some phonetic symbols of the candidate word. The phonetic symbols herein are the aforementioned IPA. In some embodiments, the replacing module 147 replaces some phonetic symbols of the candidate word with some similar phonetic symbols. For example, one phonetic symbol having a first tone is replaced with another phonetic symbol having a second tone (or a third tone, or a fourth tone), to generate the second word. By different combinations, one or more second words are generated.

In step S304, the processor 140 searches the database 120 according to at least one second word. In some embodiments, the searching module 146 searches the database 120 according to one second word, to search out the first word which is corresponding to the unknown word and associated with the first language.

In step S306, the processor 140 determines whether the first word is searched out. In some embodiments, the determining module 144 determines whether the aforementioned first word is searched out or not. If yes, step S212 is entered. If not, step S308 is entered.

In step S308, the processor 140 transforms the candidate word with a third word according to a language symbol mapping table 162. The third word includes at least one symbol or at least one number. In some embodiments, the transforming module 147 replaces some phonetic symbols of the candidate word with numbers or symbols according to the language symbol mapping table 162 in the memory 160. Under different combinations, one or more third words are generated.

In step S310, the processor 140 searches the database 120 according to at least one third word. In some embodiments, the searching module 146 searches the database 120 according to the at least one third word to search out the first word which is corresponding to the unknown word and associated with the first language.

In step S312, the processor 140 determines whether the first word is searched out or not. In some embodiments, the determining module 144 determines whether the aforementioned first word is searched out or not. If yes, step S212 is entered. If not, step S314 is entered.

In step S314, the processor 140 replaces the candidate word with a synonym according to a synonym mapping table 164. In some embodiments, the replacing module 147 replaces the candidate word with the synonym according to a synonym mapping table 164 in the memory 160. The number of the synonym is not limited to one. In some embodiments; the synonym mapping table 164 is an ordinary synonym database. In some other embodiments, the synonym mapping table 164 is an on-line synonym database and is stored in another database. The on-line synonym database is, for example, http://www.thesaurus.com.

In step S316, the processor 140 searches the database 120 according to at least one synonym. In some embodiments, the searching module 146 searches the database 120 according to the synonym, to search out the first word. The first word is corresponding to the unknown word and associated with the first language.

In step S318, the processor 140 determines whether the first word is searched out. If yes, step S212 is entered. If not, it is determined that the command transformation fails.

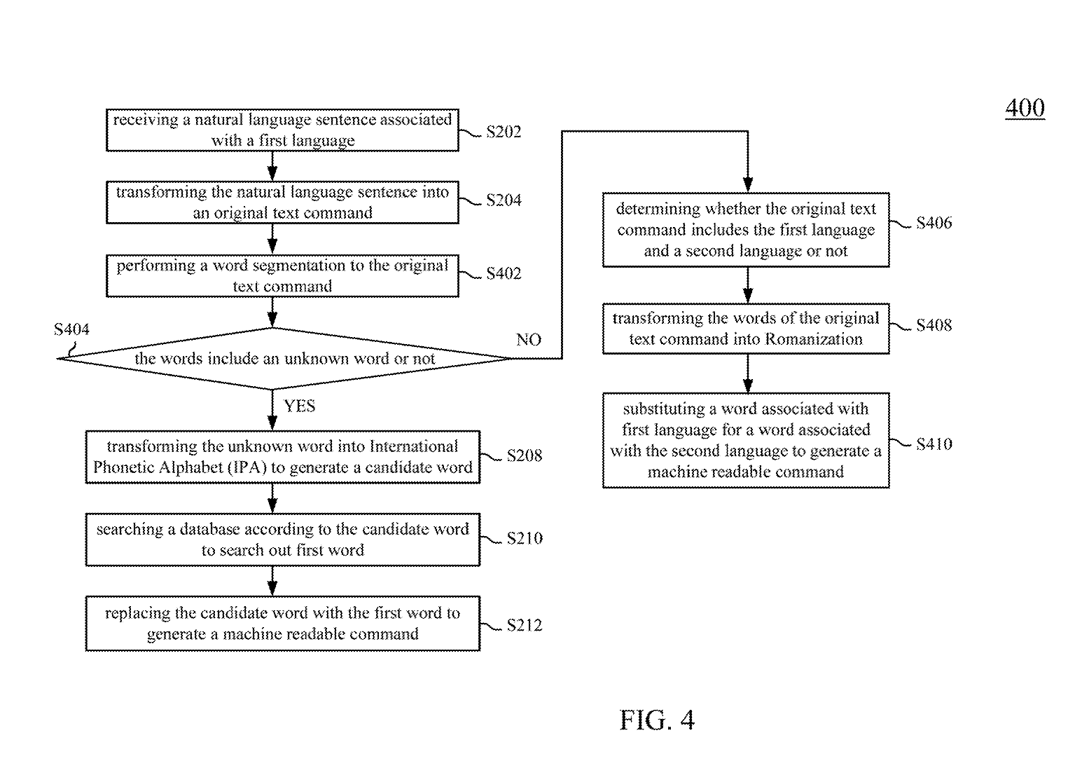

Reference is made to FIG. 4. FIG. 4 is a flow diagram illustrating a command transformation method 400 according to some embodiments of this disclosure. For ease of understanding, with respect to the embodiments of FIG. 2, like steps in FIG. 4 are designated with the same reference numbers. Only the steps in FIG. 4 which are different from the command transformation method 200 are described in following description.

In step S402, the processor 140 performs a word segmentation to the original text command. In some embodiments, the word segmentation module 143 performs the word segmentation to the original text command, to generate a plurality of words.

In step S404, the processor 140 determines whether the words include an unknown word. If yes, step S208 is entered. If not, step S406 is entered.

In step S406, the processor 140 determines whether the original text command includes the first language and a second language or not. In some embodiments, as illustratively shown in FIG. 1B, the processor 140 further includes a detecting module 155. When the words excludes the unknown word, the detecting module 155 determines whether the words includes a first language and a second language according to a first language model M1 and a second language model M2 in the memory 160. In some embodiments, the first language is different from the second language. In some embodiments, the first language is English, and the second language is Chinese. In some other embodiments, the first language is English, and the second language is a dialect corresponding to English.

In step S408, when the original text command includes the first language and the second language, the processor 140 transforms the words of the original text command into Romanization. In some embodiments, the transforming module 145 transforms the words into IPA. Then, the transforming module 156 transforms IPA into Romanization.

In step S410, the processor 140 substitutes a word associated with first language for a word associated with the second language. In some embodiments, as illustratively shown in FIG. 1B, the processor 140 further includes a substituting module 157. In some embodiments, a language mapping table 166 in the memory 160 is configured to record a relationship between a word associated with the first language and the word associated with the second language. In some embodiments, the language mapping table 166 is established in advance. In some other embodiments, the language mapping table 166 is, for example, an on-line translation dictionary, and is stored in another database. Accordingly, the substituting module 157 may substitute the word associated with first language for the word associated with the second language according to the language mapping table 166, to generate a second machine readable command. The second machine readable command is configured to be executed by the electronic device E to implement corresponding operations.

Above-mentioned modules may be implemented in terms of software, hardware and/or firmware. For example, if the execution speed and accuracy have priority, the above-mentioned modules may be implemented in terms of hardware and/or firmware. If the design flexibility has higher priority, then the above-mentioned modules may be implemented in terms of software. Furthermore, the above-mentioned modules may be implemented in terms of software, hardware and firmware in the same time.

The above description of the command transformation method 200, 300, or 400 includes exemplary operations, but the operations are not necessarily performed in the order described. The order of the operations of the command transformation method 200, 300, or 400 disclosed in the present disclosure are able to be changed, or the operations are able to be executed simultaneously or partially simultaneously as appropriate, in accordance with the spirit and scope of various embodiments of the present disclosure.

In some embodiments, the command transformation method 200, 300, or 400 may be implemented as a computer program and stored in a storing device. The storing device includes non-volatile computer-readable recording medium or other device with storing function. The computer program includes a plurality of program instructions. The CPU may execute the program instructions to perform functions of each module.

As the above embodiments, in the command transformation method and the command transformation system of this disclosure, the original text command including the unknown word is able to be transformed into the machine readable command. Thus, the electronic device is able to read the machine readable command to implement corresponding operations.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A command transformation method, configured to transform a natural language sentence into a machine readable command, wherein the command transformation method comprises:
receiving the natural language sentence associated with a first language by a processor;
transforming the natural language sentence into an original text command by the processor;
determining whether the original text command comprises an unknown word or not by the processor;
transforming the unknown word into International Phonetic Alphabet (IPA) by the processor when the original text command comprises the unknown word, to generate at least one candidate word;
searching a database according to the candidate word by the processor, to search out a first word corresponding to the unknown word and associated with the first language; and
replacing the unknown word with the first word by the processor, to generate a first machine readable command,
wherein the first machine readable command is configured to be executed by an electronic device, to implement a corresponding operation.

2. The command transformation method of claim 1, further comprising:
transforming the candidate word into a second word by the processor, wherein at least some phonetic symbols of the second words is the same as at least some phonetic symbols of the candidate word; and
searching the database according to the second word by the processor, to search out the first word.

3. The command transformation method of claim 2, further comprising:
transforming the candidate word into a third word according to a language symbol mapping table by the processor, wherein the third word comprises at least one symbol or at least one number; and
searching the database according to the third word by the processor, to search out the first word.

4. The command transformation method of claim 3, further comprising:
transforming the candidate word into a synonym according to a synonym mapping table by the processor; and
searching the database according to the synonym by the processor, to search out the first word.

5. The command transformation method of claim 1, further comprising:
performing a word segmentation to the original text command by the processor, to generate a plurality of words.

6. The command transformation method of claim 5, further comprising:
determining whether the original text command comprises the first language and a second language or not according to a plurality of language models by the processor when the plurality of words excludes the unknown word;
transforming the words into International Phonetic Alphabet and transforming International Phonetic Alphabet into Romanization by the processor when the original text command comprises the first language and the second language; and
substituting a fourth word associating with the first language of the words for a fifth word associated with the second language according to a language mapping table by the processor, to generate a second machine readable command associated with the first language, wherein the second machine readable command is configured to executed by the electronic device, to implement the corresponding operation.

7. A command transformation system, configured to transform a natural language sentence into a machine readable command, wherein the command transformation system comprises:
a database; and
a processor coupled to the database, wherein the processor is configured to receive the natural language sentence associated with a first language and to transform the natural language sentence into an original text command, the processor is further configured to determine whether the original text command comprises an unknown word or not, the processor is further configured to transform the unknown word into International Phonetic Alphabet (IPA) when the original text command comprises the unknown word to generate at least one candidate word, the processor is further configured to search a database according to the candidate word to search out a first word corresponding to the unknown word and associated with the first language, the processor is further configured to replace the unknown word with the first word to generate a first machine readable command, and the first machine readable command is configured to be executed by an electronic device to implement a corresponding operation.

8. The command transformation system of claim 7, wherein the processor is further configured to transform the candidate word into a second word, at least some phonetic symbols of the second words is the same as at least some phonetic symbols of the candidate word, and the processor s further configured to search the database according to the second word to search out the first word.

9. The command transformation system of claim 8, wherein the processor is further configured to transform the candidate word into a third word according to a language symbol mapping table, the third word comprises at least one symbol or at least one number, and the processor is further configured to search the database according to the third word to search out the first word.

10. The command transformation system of claim 9, wherein the processor is further configured to transform the candidate word into a synonym according to a synonym mapping table, and the processor is further configured to search the database according to the synonym to search out the first word.

11. The command transformation system of claim 7, wherein the processor is further configured to perform a word segmentation to the original text command to generate a plurality of words.

12. The command transformation system of claim 7, wherein the processor is further configured to determine whether the original text command comprises the first language and a second language or not according to a plurality of language models when the plurality of words excludes the unknown word, the processor is further configured to transform the words into International Phonetic Alphabet and to transform International Phonetic Alphabet into Romanization when the original text command comprises the first language and the second language, the processor is further configured to substitute a fourth word associating with the first language of the words for a fifth word associated with the second language according to a language mapping table to generate a second machine readable command associated with the first language, and the second machine readable command is configured to executed by the electronic device to implement the corresponding operation.

13. A non-transitory computer readable storage medium storing a computer program, wherein the computer program is configured to execute a command transformation method, the command transformation method is configured to transform a natural language sentence into a machine readable command, and the command transformation method comprises:
receiving the natural language sentence associated with a first language;
transforming the natural language sentence into an original text command;
determining whether the original text command comprises an unknown word or not;
transforming the unknown word into International Phonetic Alphabet (IPA) when the original text command comprises the unknown word, to generate at least one candidate word;
searching a database according to the candidate word, to search out a first word corresponding to the unknown word and associated with the first language; and
replacing the unknown word with the t word, to generate a first machine readable command,
wherein the first machine readable command is configured to be executed by an electronic device to implement a corresponding operation.
